(19) United States
(12) Patent Application Publication
(10) Pub. No.: US 2021/0390231 A1
(43) Pub. Date: Dec. 16, 2021

(54) Method for Rapidly Acquiring Multi-Field Response of Mining-induced Coal Rock

(71) Applicants: North China Institute Of Science And Technology, Beijing (CN); Chongqing University, Chongqing (CN)

(72) Inventors: Zhiheng Cheng, Beijing (CN); Quanle Zou, Zhenping County (CN); Jun Zhang, Beijing (CN); Liang Chen, Beijing (CN); Tiancheng Zhang, Xinxiang City (CN); Hui Pan, Baoding City (CN); Xin Wang, Suixi County (CN); Haoyi Chen, Bayannaoer City (CN); Lijie Zhou, Zhijin County (CN)

(21) Appl. No.: 17/349,110

(22) Filed: Jun. 16, 2021

(30) Foreign Application Priority Data
Jun. 16, 2020 (CN) 202010546115.6

(51) Int. Cl. G06F 30/25; G06F 30/27; B29C 64/118; B33Y 80/00; B33Y 70/00; B33Y 10/00

(52) U.S. Cl. CPC G06F 30/25; G06F 30/27; B33Y 10/00; B33Y 80/00; B33Y 70/00; B29C 64/118

(57) ABSTRACT

A method for rapidly acquiring multi-field response of mining-induced coal rock is provided. Based on 3D printing, the method achieves the control of material deformation and turns from 3D to 4D, thus saving manpower and material resources; further, repeated experiments may still be carried out under approximately the same conditions after each printing, so that the similarity of similarity simulations is greatly improved and a stable and reliable scientific law is conveniently obtained; besides, a BP neural network model may be built based on the data collected from similarity simulations to rapidly acquire an accurate and real coal seam mining response.

### TECHNICAL FIELD OF THE INVENTION

The present invention relates to the technical engineering field of machinery and mines, in particular to a method for rapidly acquiring multi-field response of mining-induced coal rock.

### BACKGROUND OF THE INVENTION

Coal is the main energy source in China. Before coal mining, the simulation of coal mining plays a very important role in the safe and efficient coal mining, making it necessary to develop an accurate, rapid and reliable method for acquiring a reliable mine pressure behavior, coal rock stress characteristics, development and distribution of stope fissure.

Previously, similarity model tests were able to simulate coal mines with less complex geological structures, perform mining simulations under definite conditions, and solve the problem of mining simulations of coal mines with more complex mining conditions. However, there are still many limitations. For example, it takes a long period of time to simulate and study the mine pressure behavior, coal rock stress characteristics, development and distribution of stope fissure; only a specific coal mine can be simulated and the test cannot be repeated, resulting in a high cost; and the simulation results are limited; specifically, they can only be used for the mining application of the coal mine, and relevant data cannot be used repeatedly; hence, all the values of each test data are not fully explored. Moreover, the rock parameters and geological structure parameters cannot be changed in the same test process so as to obtain a reliable and stable rock movement and evolution law by comparison, and the simulation cannot be repeated, not to mention the further construction of a method for rapidly acquiring multi-field response of coal rock.

Therefore, there is an urgent need to develop a method for acquiring multi-field response of coal rock to fill the relevant gap.

### SUMMARY OF THE INVENTION

The purpose of the present invention is to provide a method for rapidly acquiring multi-field response of mining-induced coal rock, so as to solve the problems existing in the prior art.

In order to solve the above technical problem, a technical solution adopted by the present invention is to provide a method for rapidly acquiring multi-field response of mining-induced coal rock, wherein the method includes the following steps:

1) selecting a shape memory polymer as a printer filament, setting the dip angle and thickness of coal seams and rock strata, and performing 3D printing of a similarity model to obtain a coarse model of coal seam similarity simulation;

2) applying different external field excitations to materials at different positions in the coarse model of coal seam similarity simulation, with the aim of obtaining the preset initial physical and mechanical parameters at different positions of the model and a similarity simulation model of repeated mining of coal seam, wherein the physical and mechanical parameters mainly include bulk density, compressive strength, shearing strength, tensile strength and tangential stiffness of a coal rock;

3) setting coal seam mining parameters, simulating coal seam mining, and observing the multi-field response of the coal seams and rock strata in the mining process based on the similarity simulation model of repeated mining of coal seam, wherein the multi-field response of the coal seams and rock strata includes a stress field change, a deformation field change and a fissure field change of a coal rock;

4) applying external field excitation to restore the coal seams and rock strata to the initial state of the similarity simulation model of repeated mining of coal seam, putting the excavated model memory material back into the original similarity simulation model of repeated mining of coal seam, and restoring the whole similarity simulation model of repeated mining of coal seam to the initial state through the external field excitation;

5) changing the coal seam mining parameters respectively and repeating the steps 3)-4) to obtain a multi-field response of coal rock under the condition of different mining parameters;

6) collecting the multi-field response data of the coal seams and rock strata, and processing to obtain sample data; and screening the sample data to obtain a database of modeling samples and test samples of the multi-field response of coal rock under the condition of the preset initial physical and mechanical parameters;

7) changing the initial physical and mechanical parameters of the coal seams and rock strata, and repeating the steps 2)-6) to obtain a general database of modeling samples and test samples of the multi-field response of coal rock under the condition of different initial physical and mechanical parameters;

8) changing the dip angle and thickness of the coal seams and rock strata, and repeating the steps 1)-7) to obtain a general database of modeling samples and test samples of the multi-field response of coal rock under the condition of different dip angles and thicknesses of the coal seams and rock strata;

9) analyzing the correlation between the dip angle, the thickness, the initial physical and mechanical parameters and the mining parameters of different coal seams and rock strata, and the stress field change, the deformation field change and the fissure field change of the coal rock through multivariate regression analysis of the modeling sample data;

10) determining the number of input nodes, output nodes and hidden layer nodes of BP neural network, and constructing an initial structure model of the BP neural network prediction model, wherein the initial structure model of BP neural network includes an input layer, an output layer and a hidden layer that are connected by weights;

11) optimizing a connection weight and a threshold of the BP neural network by using a particle swarm algorithm to obtain a final BP neural network prediction model; and

12) collecting basic data of actual mine, obtaining basic parameters of the mine through similarity simulation on a laboratory scale according to the similarity principle, inputting the parameters into the BP neural network prediction model to obtain a multi-field response of coal rock during the mining of coal seam on a laboratory scale, and obtaining a multi-field response of coal rock during repeated mining of real coal seam according to the similarity ratio.

Further, the similarity simulation model of repeated mining of coal seam is a similarity simulation model of repeated mining of single coal seam, and the coal seam mining parameters include a mining height and a mining speed.

Further, the similarity simulation model of repeated mining of coal seam is a similarity simulation model of repeated mining of coal seam group, and the coal seam mining parameters include a mining sequence, a mining height and a mining speed.

Further, the shape memory polymer includes the following components in parts by mass: 43 parts of quartz fine sandstone, 5-8 parts of paraffin, 20 parts of photo-thermal expansion deformer, 13 parts of argillaceous siltstone, 7 parts of antirust agent and 10 parts of calcium carbonate.

Further, in the step 1), the shape memory polymers are repeatedly stacked from bottom to top for printing, and a separation material between layers is mica powder.

Further, in the step 5), digital information of model displacement during excavation simulation is obtained by a high-precision multi-degree-of-freedom grating sensing system with laser interference, and data and related images of a stress field change of surrounding rock, a deformation field change of coal seams and rock strata, and a fissure field change are obtained through image processing.

Further, the step 9) is preceded by a step related to data cleaning of abnormal values and missing values in the original data, the K-nearest neighbors is used to replace the abnormal data values, and the missing values are complemented by the previous non-null value of the missing values.

Further, in the step 11), the normalization method is used to avoid saturation of neurons, give the input components an equal status, and prevent a local minimum of neural networks.

Further, in the step 11), the Matlab neural network toolbox is used to train and simulate the sample data according to the traingdm( ) function of the momentum BP algorithm.

Further, the step 11) specifically includes the following sub-steps:

11.1) determining the dimension of particles according to the threshold and weight of the BP neural network and generating an initial particle swarm;

11.2) continuously updating the connection weight and threshold of the BP neural network by adjusting the particle velocity and position, so that the total error of the BP neural network is less than the set value or reaches the number of iterations;

11.3) determining the initial connection weight and threshold of the BP neural network;

11.4) training the BP neural network; and

11.5) modifying the preliminary output data of the neural network by the big data-based SP-HDF storage algorithm, so as to obtain a final BP neural network prediction model.

The technical effect of the present invention is beyond doubt:

A. The test period is shortened. Upon the construction of the final BP neural network model, the corresponding data and images of a stress field change of coal rock, a deformation field change and a fissure field change can be output based on the dip angle, the thickness, the initial physical and mechanical parameters of coal rock, the coal seam mining sequence, the mining height and the mining speed only. Thus, the mining-induced multi-field parameters are more convenient to obtain a more stable and reliable scientific law.

B. An accurate and real mining response to coal seam can be acquired rapidly.

C. The stress field change of surrounding rock, the deformation, migration, failure and displacement change of rock stratum and the development of a fissure field in the stope of unexploited coal mine can be predicted, and the predicted value has strong reliability and good prediction effect.

### BRIEF DESCRIPTION OF THE DRAWING

FIG. 1 is a method flow chart.

### DETAILED DESCRIPTION OF THE PREFERRED EMBODIMENTS

The present invention is described in detail below with reference to the embodiments, but it should not be understood that the scope of the above subject matter of the present invention is limited to the following embodiments. Without departing from the technical thought of the present invention, various replacements or changes made according to the common technical knowledge and common means of the art are included in the scope of the present invention.

### EXAMPLE 1

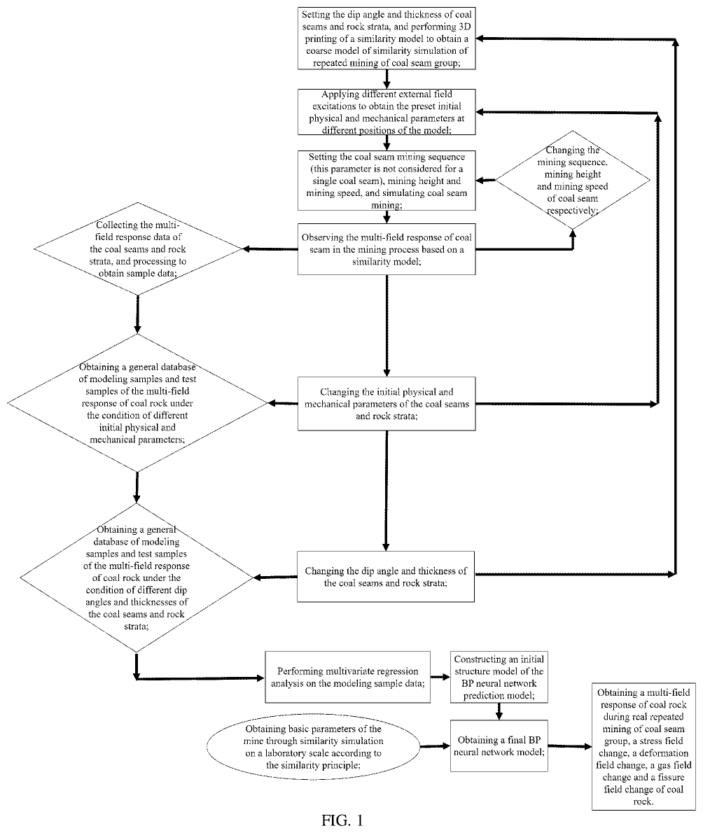

Referring to FIG. 1, the embodiment discloses a method for rapidly acquiring multi-field response of mining-induced coal rock, wherein the method includes the following steps:

1) selecting a shape memory polymer as a printer filament, setting the dip angle and thickness of coal seams and rock strata, and performing 3D printing of a similarity model to obtain a coarse model of coal seam similarity simulation, wherein the shape memory polymers are repeatedly stacked from bottom to top for printing, and a separation material between layers is mica powder;

the shape memory polymer is a new type of intelligent material that can change from the initial shape to a temporary shape and complete the fixation of the shape under the condition of different external stimuli, and then return to the initial shape when subjected to the same external stimuli again, that is, the shape memory effect; in this embodiment, the shape memory polymer includes the following components in parts by mass: 43 parts of quartz fine sandstone, 5-8 parts of paraffin, 20 parts of photo-thermal expansion deformer, 13 parts of argillaceous siltstone, 7 parts of antirust agent and 10 parts of calcium carbonate;

2) applying different external field excitations to materials at different positions in the coarse model of coal seam similarity simulation, and giving a shape, with the aim of obtaining the preset initial physical and mechanical parameters at different positions of the model and the similarity simulation model of repeated mining of coal seam, wherein the physical and mechanical parameters mainly include bulk density, compressive strength, shearing strength, tensile strength and tangential stiffness of a coal rock;

3) setting coal seam mining parameters, simulating coal seam mining, and observing the multi-field response of the coal seams and rock strata in the mining process based on the similarity simulation model of repeated mining of coal seam, wherein the multi-field response of the coal seams and rock strata includes a stress field change, a deformation field change and a fissure field change of a coal rock;

4) applying external field excitation to restore the coal seams and rock strata to the initial state of the similarity simulation model of repeated mining of coal seam, putting the excavated model memory material back into the original similarity simulation model of repeated mining of coal seam, and restoring the whole similarity simulation model of repeated mining of coal seam to the initial state through the external field excitation;

5) changing the coal seam mining parameters respectively and repeating the steps 3)-4) to obtain a multi-field response of coal rock under the condition of different mining parameters;

6) collecting the multi-field response data of the coal seams and rock strata, and processing to obtain sample data; and screening the sample data to obtain a database of modeling samples and test samples of the multi-field response of coal rock under the condition of the preset initial physical and mechanical parameters;

7) changing the initial physical and mechanical parameters of the coal seams and rock strata, and repeating the steps 2)-6) to obtain a general database of modeling samples and test samples of the multi-field response of coal rock under the condition of different initial physical and mechanical parameters;

8) changing the dip angle and thickness of the coal seams and rock strata, and repeating the steps 1)-7) to obtain a general database of modeling samples and test samples of the multi-field response of coal rock under the condition of different dip angles and thicknesses of the coal seams and rock strata;

9) adding a step related to data cleaning of abnormal values and missing values in the original data, replacing the abnormal data values with the K-nearest neighbors, and complementing the missing values by the previous non-null value of the missing values; according to the characteristics of different dimensional values in the data, scaling the data by the Min Max Scala method to improve the running efficiency of the model;

10) analyzing the correlation between the dip angle, the thickness, the initial physical and mechanical parameters and the mining parameters of different coal seams and rock strata, and the stress field change, the deformation field change and the fissure field change of the coal rock through multivariate regression analysis of the modeling sample data;

11) determining the number of input nodes, output nodes and hidden layer nodes of BP neural network, and constructing an initial structure model of the BP neural network prediction model, and

12) optimizing the connection weights and thresholds of back propagation (BP) neural network by particle swarm optimization (PSO), and modifying by the genetic image location algorithm to obtain the final BP neural network prediction model;

12.1) determining the dimension of particles according to the threshold and weight of the BP neural network and generating an initial particle swarm;

12.2) continuously updating the connection weight and threshold of the BP neural network by adjusting the particle velocity and position, so that the total error of the BP neural network is less than the set value or reaches the number of iterations, wherein the formula for adjusting the speed for the i^{th} time is:

Vᵢ=ηᵢvᵢ+μ₁ω₁[pᵢ−xᵢ]+μ₂ω₂[pᵢ−xᵢ]

The formula of inertia transfer weighting factor is:

ηᵢ=ηₘₐₓ−t(ηₘₐₓ−ηₘᵢₙ)/tₘₐₓ

where, η is an inertia weight factor, μ is a learning factor, ω is a random number in [0,1], and t is iterations.

12.3) determining the initial connection weight and threshold of the BP neural network;

12.4) training the BP neural network, and using the Matlab neural network toolbox to train and simulate the sample data according to the traingdm( ) function of the momentum BP algorithm, wherein the initial structure model of BP neural network includes an input layer, an output layer and a hidden layer that are connected by weights;

12.5) modifying the preliminary output data of the neural network by the big data-based SP-HDF storage algorithm, combined with neural network, so as to obtain a final BP neural network prediction model, wherein SP-HDF adopts a hierarchical data structure to manage and store data scientifically; in this embodiment, the modification to the algorithm mainly includes constructing data sheet through data transformation, constructing visual structure through visual mapping, constructing view through view transformation, evaluating and verifying, and connecting through neural network; and the obtained data is visible, easy to use and easy to manage.

13) collecting basic data of actual mine, obtaining basic parameters of the mine through similarity simulation on a laboratory scale according to the similarity principle, inputting the parameters into the BP neural network prediction model to obtain a multi-field response of coal rock during the mining of coal seam on a laboratory scale, and obtaining a multi-field response of coal rock during repeated mining of real coal seam according to the similarity ratio.

It is worth noting that the coal seam mining parameters include a mining height and a mining speed when the similarity simulation model of repeated mining of coal seam is a similarity simulation model of repeated mining of single coal seam. The coal seam mining parameters include a mining sequence, a mining height and a mining speed when the similarity simulation model of repeated mining of coal seam is a similarity simulation model of repeated mining of coal seam group.

### EXAMPLE 2

The embodiment discloses a method for rapidly acquiring multi-field response of mining-induced coal rock, wherein the method includes the following steps:

1) selecting a shape memory polymer as a printer filament, setting the dip angle and thickness of coal seams and rock strata, and performing 3D printing of a similarity model to obtain a coarse model of coal seam similarity simulation;

2) applying different external field excitations to materials at different positions in the coarse model of coal seam similarity simulation, with the aim of obtaining the preset initial physical and mechanical parameters at different positions of the model and a similarity simulation model of repeated mining of coal seam, wherein the physical and mechanical parameters mainly include bulk density, compressive strength, shearing strength, tensile strength and tangential stiffness of a coal rock;

3) setting coal seam mining parameters, simulating coal seam mining, and observing the multi-field response of the coal seams and rock strata in the mining process based on the similarity simulation model of repeated mining of coal seam, wherein the multi-field response of the coal seams and rock strata includes a stress field change, a deformation field change and a fissure field change of a coal rock;

4) applying external field excitation to restore the coal seams and rock strata to the initial state of the similarity simulation model of repeated mining of coal seam, putting the excavated model memory material back into the original similarity simulation model of repeated mining of coal seam, and restoring the whole similarity simulation model of repeated mining of coal seam to the initial state through the external field excitation;

5) changing the coal seam mining parameters respectively and repeating the steps 3)-4) to obtain a multi-field response of coal rock under the condition of different mining parameters;

6) collecting the multi-field response data of the coal seams and rock strata, and processing to obtain sample data; and screening the sample data to obtain a database of modeling samples and test samples of the multi-field response of coal rock under the condition of the preset initial physical and mechanical parameters;

7) changing the initial physical and mechanical parameters of the coal seams and rock strata, and repeating the steps 2)-6) to obtain a general database of modeling samples and test samples of the multi-field response of coal rock under the condition of different initial physical and mechanical parameters;

8) changing the dip angle and thickness of the coal seams and rock strata, and repeating the steps 1)-7) to obtain a general database of modeling samples and test samples of the multi-field response of coal rock under the condition of different dip angles and thicknesses of the coal seams and rock strata;

9) analyzing the correlation between the dip angle, the thickness, the initial physical and mechanical parameters and the mining parameters of different coal seams and rock strata, and the stress field change, the deformation field change and the fissure field change of the coal rock through multivariate regression analysis of the modeling sample data;

10) determining the number of input nodes, output nodes and hidden layer nodes of BP neural network, and constructing an initial structure model of the BP neural network prediction model, wherein the initial structure model of BP neural network includes an input layer, an output layer and a hidden layer that are connected by weights;

11) optimizing a connection weight and a threshold of the BP neural network by using a particle swarm algorithm to obtain a final BP neural network prediction model; and

12) collecting basic data of actual mine, obtaining basic parameters of the mine through similarity simulation on a laboratory scale according to the similarity principle, inputting the parameters into the BP neural network prediction model to obtain a multi-field response of coal rock during the mining of coal seam on a laboratory scale, and obtaining a multi-field response of coal rock during repeated mining of real coal seam according to the similarity ratio.

### EXAMPLE 3

The main steps of Example 3 are the same as those of Example 2, wherein the similarity simulation model of repeated mining of coal seam is a similarity simulation model of repeated mining of single coal seam, and the coal seam mining parameters include a mining height and a mining speed.

### EXAMPLE 4

The main steps of Example 4 are the same as those of Example 2, wherein the similarity simulation model of repeated mining of coal seam is a similarity simulation model of repeated mining of coal seam group, and the coal seam mining parameters include a mining sequence, a mining height and a mining speed.

### EXAMPLE 5

The main steps of Example 5 are the same as those of Example 2, wherein the shape memory polymer includes the following components in parts by mass: 43 parts of quartz fine sandstone, 5-8 parts of paraffin, 20 parts of photo-thermal expansion deformer, 13 parts of argillaceous siltstone, 7 parts of antirust agent and 10 parts of calcium carbonate. In the step 1), the shape memory polymers are repeatedly stacked from bottom to top for printing, and a separation material between layers is mica powder

### EXAMPLE 6

The main steps of Example 6 are the same as those of Example 2, wherein in the step 5), digital information of model displacement during excavation simulation is obtained by a high-precision multi-degree-of-freedom grating sensing system with laser interference, and data and related images of a stress field change of surrounding rock, a deformation field change of coal seams and rock strata, and a fissure field change are obtained through image processing.

### EXAMPLE 7

The main steps of Example 7 are the same as those of Example 2, wherein, the step 9) is preceded by a step related to data cleaning of abnormal values and missing values in the original data, the K-nearest neighbors is used to replace the abnormal data values, and the missing values are complemented by the previous non-null value of the missing values; according to the characteristics of different dimensional values in the data, the data is scaled by the Min Max Scala method to improve the running efficiency of the model.

### EXAMPLE 8

The main steps of Example 8 are the same as those of Example 2, wherein in the step 11), the normalization method is used to avoid saturation of neurons, give the input components an equal status, and prevent a local minimum of neural networks.

### EXAMPLE 9

The main steps of Example 9 are the same as those of Example 2, wherein the step 11) specifically includes the following sub-steps:

11.1) determining the dimension of particles according to the threshold and weight of the BP neural network and generating an initial particle swarm;

11.2) continuously updating the connection weight and threshold of the BP neural network by adjusting the particle velocity and position, so that the total error of the BP neural network is less than the set value or reaches the number of iterations;

11.3) determining the initial connection weight and threshold of the BP neural network;

11.4) training the BP neural network, and using the Matlab neural network toolbox to train and simulate the sample data according to the traingdm( ) function of the momentum BP algorithm; and

11.5) modifying the preliminary output data of the neural network by the big data-based SP-HDF storage algorithm, so as to obtain a final BP neural network prediction model.

### EXAMPLE 10

The main steps of Example 10 are the same as those of Example 2, wherein the printing method of pleats includes repeated printing from bottom to top by a double-layer structure that is composed of materials with different proportions, adjusting according to the shapes of different pleats, and finally obtaining different 4D deformed shapes through accurate light intensity and temperature. In the printing process, the printing angle is in the range of 0±22.5° or 45±22.5°. Actually, the bending deformation of the shaft surface is achieved by the change of the light or sound intensity. To obtain a large degree of bending, the printing angle range shall be broadened. The greater the difference between the two angles, the greater the degree of bending that can be achieved.

### EXAMPLE 11

The embodiment provides a method for rapidly acquiring multi-field response of mining-induced coal rock, wherein the method includes the following steps:

1) determining a similarity ratio based on the similarity principle and selecting a shape memory polymer as a printer filament, wherein the shape memory polymer includes the following components in parts by mass: 43 parts of quartz fine sandstone, 5-8 parts of paraffin, 20 parts of photo-thermal expansion deformer, 13 parts of argillaceous siltstone, 7 parts of antirust agent and 10 parts of calcium carbonate;

2) collecting the rock sample of the mine to be simulated, obtaining the relevant simulation range of the physical and mechanical properties of rock strata through the physical and mechanical test and spectrum analysis of the rock samples, and determining the mechanical strength of the model according to the mechanical similarity ratio between the model and the prototype;

3) determining the geometric similarity ratio and geometric dimension of the model strata according to the actual geological data and similarity ratio of the mine to be simulated, performing 3-D printing of the similarity model, and obtaining a coarse model of similar geological structure of coal mine, wherein in this embodiment, the shape memory polymers are repeatedly stacked from bottom to top for printing, and a separation material between layers is mica powder;

4) applying different external field excitations to materials in different positions in the coarse model of similar geological structure, and giving a temporary shape to obtain different physical and mechanical properties parameters in different positions of the model, wherein the physical and mechanical parameters include bulk density, compressive strength, shearing strength, tensile strength and tangential stiffness of rocks; compared with the relevant mechanical properties determined in the step 2), the intensity of relevant external field stimulation is controlled according to the dip angle of coal seam to be formed; and the occurrence size of pleats is controlled by temperature in this embodiment;

5) setting the coal seam mining sequence (this parameter is not considered for a single coal seam), mining height and mining speed, simulating coal seam mining, and observing the multi-field response of coal seam in the mining process based on a similarity model, wherein the multi-field response of the coal seams and rock strata includes a stress field change, a deformation field change and a fissure field change of a coal rock;

6) applying external field excitations from top to bottom to restore the roof strata of the protective layer, the surrounding rock under the protective layer, the bottom plate of the protective layer and the roof strata of the protected layer into the original shape of the model, putting the excavated model memory material back to the protective layer and the protected layer in the original model by a mechanical arm, healing the broken layers of overlying rock memory material by an external field excitation, applying an external field excitation to restore the coal seams and rock strata into the initial state of the model, putting the excavated model memory material back into the original model, and restoring the whole similarity model to the initial state of the physical state determined in this experimental cycle by an external field excitation;

7) collecting the multi-field response data of the coal seams and rock strata, and processing to obtain sample data; and screening the sample data to obtain a database of modeling samples and test samples of the multi-field response of coal rock under the condition of the initial physical and mechanical parameters;

8) changing the initial conditions of coal seam, and repeating the steps 4)-7) to obtain the rock stratum evolution law under different initial conditions, different mining sequences, different mining heights and different mining rates, and a general database of modeling samples and test samples under different initial conditions of coal seam;

9) changing the initial physical and mechanical parameters of the coal seams and rock strata, and repeating the steps 2)-7) to obtain a general database of modeling samples and test samples of the multi-field response of coal rock under the condition of different initial physical and mechanical parameters;

10) constructing an initial model of the BP neural network structure, wherein the initial model of BP neural network structure includes an input layer, an output layer and a hidden layer that are connected by weights;

11) training the constructed initial model of BP neural network in an Matlab environment, getting an error mean and an error standard deviation under the condition of different network layers, training functions, number of nodes in the hidden layer and node transfer functions, and determining the final model of BP neural network, wherein in the final model of BP neural network, Tan sig function is used as the transfer function of hidden layer neurons, Log sig function is used as the transfer function of output layer neurons, and Traingdm function is used as the training function;

12) obtaining the final model of BP neural network, inputting different original parameters and mining information of coal mine, including a mining sequence, a mining height and a mining sequence, and outputting corresponding data and relevant images of the stress field change of surrounding rock, the deformation, migration, damage and displacement change of rock stratum and the development of a fissure field.

### EXAMPLE 12

The embodiment discloses a method for rapidly acquiring multi-field response of mining-induced coal rock, wherein the method includes the following steps:

1) determining a similarity ratio based on the similarity principle and selecting a shape memory polymer as a printer filament, wherein the shape memory polymer includes the following components in parts by mass: 43 parts of quartz fine sandstone, 5-8 parts of paraffin, 20 parts of photo-thermal expansion deformer, 23 parts of argillaceous siltstone, 7 parts of antirust agent and 10 parts of calcium carbonate; the shape memory polymer may absorb water and dehydrate uniformly, and does not deform obviously when absorbing water; after the material is expanded and deformed by light and heat excitation, its mass or volume may be uniformly expanded to be dozens of times of the original one, so as to achieve the purpose of model adjustment;

2) under the condition that the shape memory polymer meets the geometric similarity ratio and mass similarity ratio of similar material similarity experiments, and meets the similarity principle, carrying out physical and mechanical tests and electron microscope energy spectrum analysis of the rock samples collected in the field to obtain the simulation range of physical and mechanical properties of the coal rock with large dip angle to be simulated;

3) determining the mechanical strength of the model according to the mechanical similarity ratio between the model and prototype, and adjusting the material ratio according to the relevant strength and parameters to meet the relevant requirements;

4) simulating the geometric similarity template and geological structure similarity according to the geological data related to the field investigation of rock strata to be printed, and performing 3D printing according to the simulation model, so as to obtain the coarse structural model of the coal mine with a large dip angle; taking mica powder as a separation material between layers in the process of 3D printing, using a double-layer structure, and repeatedly stacking the shape memory polymers from bottom to top for printing; wherein the double-layer structure is composed of materials with different proportions, and the material composition is guided by the theoretical simulation results;

5) setting the coal seam mining sequence (this parameter is not considered for a single coal seam), mining height and mining speed, simulating coal seam mining, and observing the multi-field response of coal seam in the mining process based on a similarity model, wherein the multi-field response of the coal seams and rock strata includes a stress field change, a deformation field change and a fissure field change of a coal rock;

6) upon the completion of excavation, restoring the overlying strata to the original shape of the model by temperature excitation or light excitation, putting the excavated model memory material to the original model by a mechanical arm, and healing the broken memory material of the overlying rock to restore the model to the state before excavation;

7) changing the mining sequence, mining height and mining speed of coal seam respectively, repeating the steps 3)-6) to obtain a multi-field response of coal rock under the condition of different mining sequences, mining heights and mining speeds, and separating three copies of data with different mining sequence and different working face spacing separately as the final neural network test sample;

8) collecting the multi-field response data of the coal seams and rock strata, and processing to obtain sample data; and screening the sample data to obtain a database of modeling samples and test samples of the multi-field response of coal rock under the condition of the initial physical and mechanical parameters;

9) changing the initial physical and mechanical parameters of the coal seams and rock strata, and repeating the steps 2)-8) to obtain a general database of modeling samples and test samples of the multi-field response of coal rock under the condition of different initial physical and mechanical parameters;

10) changing the dip angle and thickness of the coal seams and rock strata, and repeating the steps 2)-9) to obtain a general database of modeling samples and test samples of the multi-field response under the condition of different dip angles and thicknesses of the coal seams and rock strata;

11) cleaning abnormal values and missing values in the original data, replacing the abnormal data values with the K-nearest neighbors, and complementing the missing values by the previous non-null value of the missing values; according to the characteristics of different dimensional values in the data, scaling the data by the Min Max Scala method to improve the running efficiency of the model;

12) performing the linear regression analysis on the collected stress field changes, fissure field development changes, and deformation, movement and displacement field changes of roof strata according to the principle of multiple linear regression analysis; wherein the multiple linear regression analysis is carried out by SPSS software, with the aiming of analyzing the correlation between several mechanical parameters of several rocks, mining sequence and working face spacing on mine pressure behavior of stope, and surrounding rock movement, fissure development and fissure of fully-mechanized face, and preliminarily verifying the reliability of the model;

13) determining the selection factors of neurons in the input layer through linear regression analysis, including physical properties of rocks, e.g. the dip angle and thickness of the coal seams and rock strata, mining sequence and working face spacing; constructing a BP neural network model combined with Kolmogorov theorem and engineering practice; wherein, in the established network model structure, the first layer is the input neuron node, including coal seam mining sequence, mining height and mining speed, the number of which is determined by the main influencing factors obtained by linear regression analysis, the middle layer is the neural hidden unit, the lower layer is the output layer to get the prediction results, and the layers are connected by weights;

14) writing the algorithm calculation program by Matlab language, using and adding a PSO algorithm-optimized BP neural network prediction model; wherein the initialization parameters include the limited interval of population size, number of iterations, learning factors, different dip angles and thicknesses, different initial physical and mechanical parameters, different mining sequences, different mining heights and different mining speeds of coal seams and rock strata; the constructed BP neural network initial model is trained according to the general database obtained through simulated mining, so as to obtain the error mean and error standard deviation under the condition of different network layers, training functions, hidden layer nodes and node transfer functions, and determine a final model of BP neural network;

15) then training and simulating the sample data by Matlab neural network toolbox, testing the results of three experiments in various situations reserved in the previous experiment based on the trained BP neural network prediction model, inputting relevant influencing factors, including rock mechanics properties, mining sequence and working face spacing to obtain the mine pressure behavior of stope, surrounding rock movement, crack development and fissure law of fully mechanized face, and comparing with the results obtained in the previous experiment; and

16) locating and outputting images of the stress field change, the deformation, migration, damage and displacement change of rock stratum, and development of a fissure field based on the improved genetic algorithm of the BP neural network.

What is claimed is:

1. A method for rapidly acquiring multi-field response of mining-induced coal rock, comprising the following steps:
1) selecting a shape memory polymer as a printer filament, setting a dip angle and a thickness of coal seams and rock strata, and performing 3D printing of a similarity model to obtain a coarse model of coal seam similarity simulation;
2) applying different external field excitations to materials at different positions in the coarse model of coal seam similarity simulation, with an aim of obtaining preset initial physical and mechanical parameters at different positions of the coarse model and a similarity simulation model of repeated mining of coal seam, wherein the physical and mechanical parameters mainly comprise bulk density, compressive strength, shearing strength, tensile strength and tangential stiffness of a coal rock;
3) setting coal seam mining parameters, simulating coal seam mining, and observing multi-field response of the coal seams and the rock strata in a mining process based on the similarity simulation model of repeated mining of coal seam, wherein the multi-field response of the coal seams and the rock strata comprises a stress field change, a deformation field change and a fissure field change of the coal rock;
4) applying an external field excitation to restore the coal seams and the rock strata to an initial state of the similarity simulation model of repeated mining of coal seam, putting an excavated model memory material back into an original similarity simulation model of repeated mining of coal seam, and restoring a whole similarity simulation model of repeated mining of coal seam to the initial state through the external field excitation;
5) changing the coal seam mining parameters respectively and repeating the steps 3)-4) to obtain a multi-field response of coal rock under different mining parameters;
6) collecting multi-field response data of the coal seams and the rock strata, and processing to obtain sample data; and screening the sample data to obtain a database of modeling samples and test samples of the multi-field response of coal rock under the condition of the preset initial physical and mechanical parameters;
7) changing the initial physical and mechanical parameters of the coal seams and rock strata, and repeating the steps 2)-6) to obtain a general database of modeling samples and test samples of the multi-field response of coal rock under the condition of different initial physical and mechanical parameters;
8) changing the dip angle and the thickness of the coal seams and the rock strata, and repeating the steps 1)-7) to obtain a general database of modeling samples and test samples of the multi-field response of coal rock under the condition of different dip angles and thicknesses of the coal seams and the rock strata;
9) analyzing the correlation between the dip angle, the thickness, the initial physical and mechanical parameters and the mining parameters of different coal seams and rock strata, and the stress field change, the deformation field change and the fissure field change of the coal rock through multivariate regression analysis of the modeling sample data;
10) determining the number of input nodes, output nodes and hidden layer nodes of BP neural network, and constructing an initial structure model of the BP neural network prediction model, wherein the initial structure model of BP neural network comprises an input layer, an output layer and a hidden layer that are connected by weights;
11) optimizing a connection weight and a threshold of the BP neural network by using a particle swarm algorithm to obtain a final BP neural network prediction model; and
12) collecting basic data of actual mine, obtaining basic parameters of the mine through similarity simulation on a laboratory scale according to the similarity principle, inputting the parameters into the BP neural network prediction model to obtain the multi-field response of coal rock during the mining of coal seam on a laboratory scale, and obtaining the multi-field response of coal rock during repeated mining of real coal seam according to the similarity ratio.

2. The method for rapidly acquiring multi-field response of mining-induced coal rock according to claim 1, wherein the similarity simulation model of repeated mining of coal seam is a similarity simulation model of repeated mining of single coal seam, and the coal seam mining parameters comprise a mining height and a mining speed.

3. The method for rapidly acquiring multi-field response of mining-induced coal rock according to claim 1, wherein the similarity simulation model of repeated mining of coal seam is a similarity simulation model of repeated mining of coal seam group, and the coal seam mining parameters comprise a mining sequence, a mining height and a mining speed.

4. The method for rapidly acquiring multi-field response of mining-induced coal rock according to claim 2, wherein the similarity simulation model of repeated mining of coal seam is a similarity simulation model of repeated mining of coal seam group, and the coal seam mining parameters comprise a mining sequence, a mining height and a mining speed.

5. The method for rapidly acquiring multi-field response of mining-induced coal rock according to claim 1, wherein the shape memory polymer comprises the following components in parts by mass: 43 parts of quartz fine sandstone, 5-8 parts of paraffin, 20 parts of photo-thermal expansion deformer, 13 parts of argillaceous siltstone, 7 parts of antirust agent and 10 parts of calcium carbonate.

6. The method for rapidly acquiring multi-field response of mining-induced coal rock according to claim 3, wherein the shape memory polymer comprises the following components in parts by mass: 43 parts of quartz fine sandstone, 5-8 parts of paraffin, 20 parts of photo-thermal expansion deformer, 13 parts of argillaceous siltstone, 7 parts of antirust agent and 10 parts of calcium carbonate.

7. The method for rapidly acquiring multi-field response of mining-induced coal rock according to claim 2, wherein in the step 1), the shape memory polymers are repeatedly stacked from bottom to top for printing, and a separation material between layers is mica powder.

8. The method for rapidly acquiring multi-field response of mining-induced coal rock according to claim 1, wherein in the step 5), digital information of model displacement during excavation simulation is obtained by a high-precision multi-degree-of-freedom grating sensing system with laser interference, and data and related images of a stress field change of surrounding rock, a deformation field change of coal seams and rock strata, and a fissure field change are obtained through image processing.

9. The method for rapidly acquiring multi-field response of mining-induced coal rock according to claim 1, wherein the step 9) is preceded by a step related to data cleaning of abnormal values and missing values in the original data, the K-nearest neighbors is used to replace the abnormal data values, and the missing values are complemented by the previous non-null value of the missing values.

8. The method for rapidly acquiring multi-field response of mining-induced coal rock according to claim 1, wherein in the step 11), the normalization method is used to avoid saturation of neurons, give the input components an equal status, and prevent a local minimum of neural networks.

10. The method for rapidly acquiring multi-field response of mining-induced coal rock according to claim 1, wherein in the step 11), the Matlab neural network toolbox is used to train and simulate the sample data according to the traingdm( ) function of the momentum BP algorithm.

11. The method for rapidly acquiring multi-field response of mining-induced coal rock according to claim 1, wherein the step 11) specifically comprises the following sub-steps:
11.1) determining the dimension of particles according to the threshold and weight of the BP neural network and generating an initial particle swarm;
11.2) continuously updating the connection weight and threshold of the BP neural network by adjusting the particle velocity and position, so that the total error of the BP neural network is less than the set value or reaches the number of iterations;
11.3) determining the initial connection weight and threshold of the BP neural network;
11.4) training the BP neural network; and
11.5) modifying the preliminary output data of the neural network by the big data-based SP-HDF storage algorithm, so as to obtain a final BP neural network prediction model.
